(19) United States
(12) Patent Application Publication
(10) Pub. No.: US 2007/0143642 A1
(43) Pub. Date: Jun. 21, 2007

(54) Circui and method for reducing interference from switched mode circuits

(75) Inventor: Jozef Reinerus Maria Bergervoet, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA EINDHOVEN (NL)

(21) Appl. No.: 10/529,681

(22) PCT Filed: Aug. 18, 2003
(86) PCT No.: PCT/IB03/03674

§ 371 Date: Mar. 29, 2005

(30) Foreign Application Priority Data
Oct. 2, 2002 (EP) 02079096.0

(51) Int. Cl. G06F 1/00

(52) U.S. Cl. 713/501

(57) ABSTRACT

A switched-mode control circuit (1) for a switched-mode power supply or an audio amplifier. It comprises a monitoring loop (3) for the output signal of the switched-mode circuit (2). A tuner (7) supplies the reference signal, which is related to the protected frequency or frequency band. The monitoring loop (3) comprises two quadrature mixers (4, 5) with a filter (6) in between and generates a correction signal which leads back to the switched-mode circuit (2). The corrective changes performed by the monitoring loop (3) are synchronization pulses that are added to the reference signal. This results in a shifting in time of each switching position of the switched-mode circuit (2).

The invention relates to a switched-mode power circuit, such as a switched-mode power supply or audio amplifiers. It particularly relates to the control of such a switched-mode power circuit. The invention can be used, for example, in switched-mode power supplies and/or switched-mode power amplifiers in audio sets containing AM receivers.

Switched-mode power supplies produce electromagnetic emission. There are various methods of reducing electromagnetic emission. One of them is the shielding and filtering of the signals. Another method is the prudent choice of the operating frequency. In some cases, such as the application of the switched-mode power supply and/or switched-mode power amplifier in an audio set containing an AM receiver, for instance, these known methods do not solve the problem of electromagnetic compatibility (EMC). In this case, the emission may be approximately 50 dB too high for AM reception with a local antenna.

In some cases, shielding alone may not achieve the desired improvements and may also be too expensive. In other cases, the operating frequency cannot be freely chosen, as part of the spectrum may be unusable due to sideband overlap of the switched-mode harmonics (this is especially true in the case of switched-mode power amplifiers).

U.S. Pat. No. 5,537,305 discloses a synchronously tuned power converter method and apparatus. This improved switching power supply includes a variable frequency-switching circuit. The switching circuit frequency is varied to minimize the interaction between the generated power supply noise and an electronic device powered by the power supply. The operating frequency or frequencies of the powered electronics device are monitored to allow the continuous real time control of the switching circuit frequency. As a consequence of the monitoring, the oscillator is set at a frequency which ensures that no disturbance is caused.

It is therefore an object of the invention to provide a switched-mode control circuit that is easy to realize and does not require shielding. It is another object of the invention to provide a method of diminishing the electromagnetic emission caused by a switched-mode circuit.

As regards the switched-mode control circuit, the object is solved by a switched-mode control circuit generating an output signal and comprising a switched-mode circuit that is indirectly coupled to a tuner, which in turn supplies the switched-mode control circuit with a reference signal comprising, or related to, a frequency or frequency band that is to be protected by the switched-mode control circuit, and which has a monitoring loop for monitoring the output signal.

As regards the method, the object is solved by a method of diminishing the electromagnetic emission of a switched-mode circuit that is indirectly coupled to a tuner, which in turn supplies a reference signal comprising a frequency or frequency band that is to be protected, characterized by the steps of:

receiving the reference signal that comprises the protected frequency or frequency band,

monitoring the frequency components of at least a small frequency band of the output signal of the switched-mode circuit output signal,

detecting interference signals in the protected frequency or frequency band, and

introducing corrective changes in the output signal

so as to create a hole around the protected frequency or frequency band.

In a preferred embodiment, the monitoring loop comprises:

a means for receiving a reference signal that comprises, or is related to, the protected frequency or frequency band,

a means for detecting the interference within the protected frequency band present in the output signal, and

a means for introducing corrective changes in the output signal.

It is advantageous if the means of the monitoring loop for receiving a signal, i.e. the protected frequency or frequency band, comprises two parallel quadrature mixers coupled by a filter. The quadrature mixers and the filter are easy to realize and are less expensive and take up less space than a common shielding.

In addition, the monitoring loop has

a means for generating a correction signal and

a means for introducing corrective changes in the output signal of the switched-mode circuit.

The corrective changes are synchronization pulses and are performed by shifting in time each individual switching moment, i.e. each switching position. The shifting concerns a small fraction of a full period and is performed in a controlled manner. This results in a varied electromagnetic emission from the switched-mode power supply. In particular, the electromagnetic emission at certain frequencies in the protected frequency band can be substantially reduced in this way.

These and other aspects of the invention are apparent from and will be elucidated with reference to the embodiments concerning an audio amplifier and described hereinafter, wherein

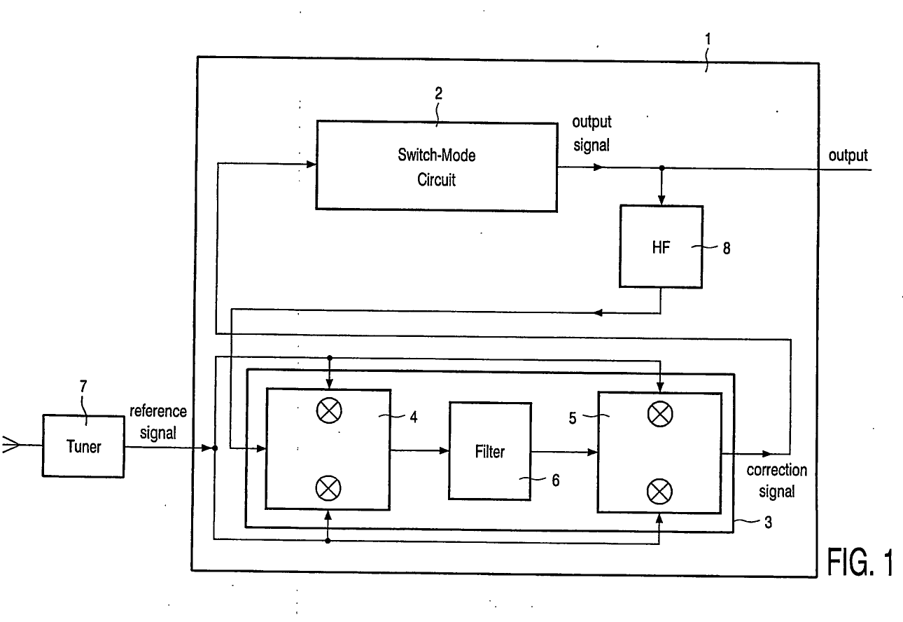

FIG. 1 is a block diagram of the basic elements of the inventive switched-mode control circuit;

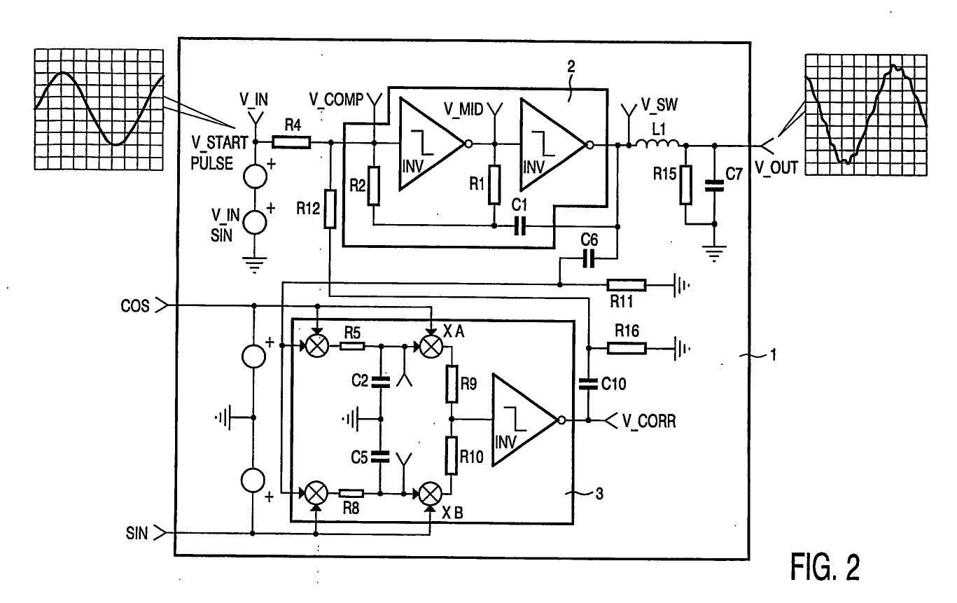

FIG. 2 shows one implementation of the switched-mode control circuit;

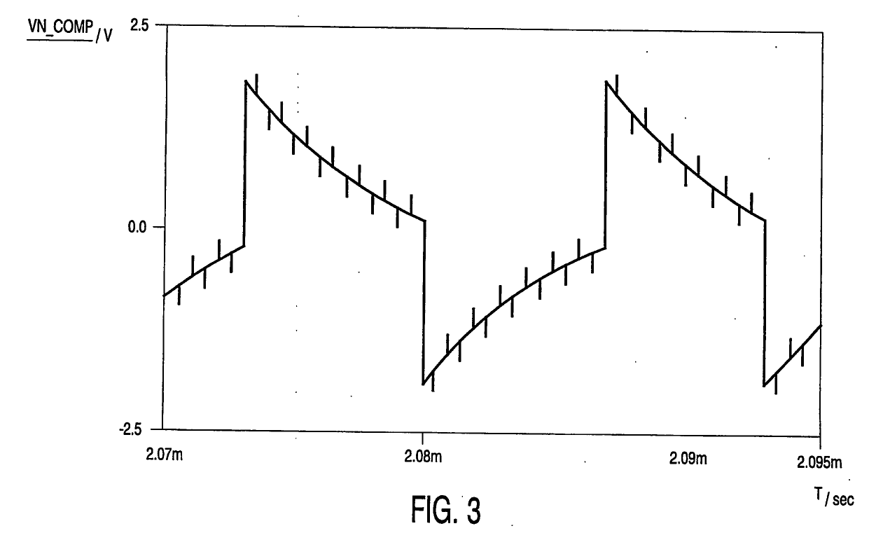

FIG. 3 shows the synchronization pulses that are added to the input signal;

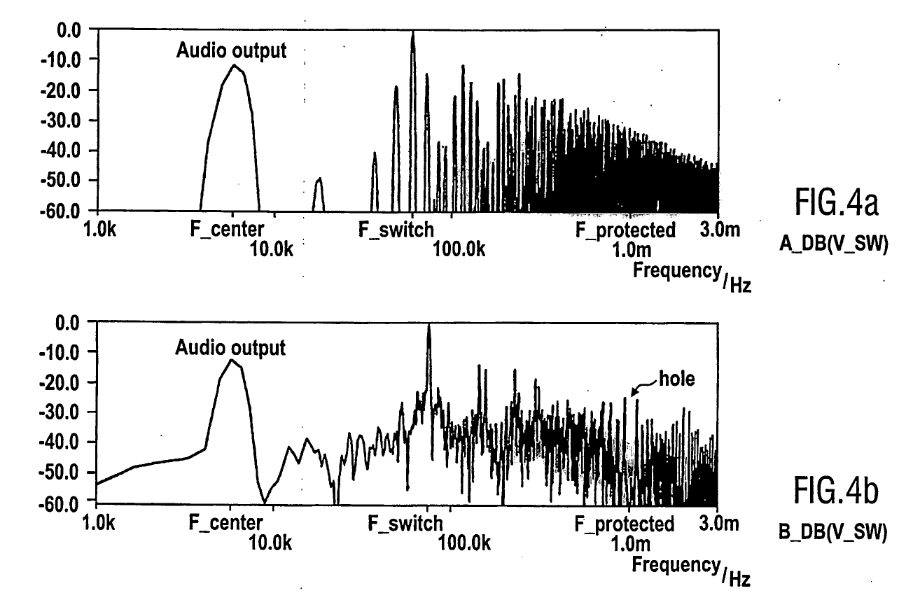

FIG. 4 shows in a) the spectrum of the unfiltered output of the switched-mode circuit for prior-art operation and in b) the spectrum of the output of the unfiltered switched-mode circuit for operation with the inventive frequency protection.

FIG. 1 is a block diagram of the basic elements of the inventive switched-mode control circuit 1. The basic elements are a switched-mode circuit 2 and a monitoring loop 3 comprising two quadrature mixers 4, 5 with a filter 6 in between. The reference signal for the control loop 3 is supplied by a tuner 7. The frequency of the communications channel being received by the tuner 7 is the frequency to be protected. Each quadrature mixer 4, 5 has two inputs for the reference signal supplied by the tuner 7. The filter 6 between the two quadrature mixers 4, 5 serves as a memory with regard to any interference that has been detected so far. The output of the monitoring loop 3 is coupled to the input of the switched-mode circuit 2. The output of the switched-mode circuit 2 leads back to the quadrature mixers 4, 5 via a high frequency-filter 8. The monitoring loop 3 generates a correction signal by introducing corrective changes in the output signal of the switched-mode circuit 2.

FIG. 2 shows one implementation of the switched-mode control circuit 1 that essentially consists of two parts—one part concerning a switched-mode circuit 2 and another part concerning the monitoring loop 3 for the protected frequency or frequency band. The protected frequency band is, for example, the carrier frequency of an AM station together with the sidebands, i.e. the modulation sidebands surrounding it, if the switched-mode control circuit 1 is used in a medium-wave AM receiver. The center frequency of the protected band is provided by a tuner. The center frequency enters the switched-mode control circuit 1 as a quadrature signal including sine and cosine components at the corresponding tuner connections. The control loop 3 comprising components R5, C2, R8 and C5 monitors the spectral content in the protected frequency band. Each of the two signals received at the two tuner connections is supplied to two mixers, so that each input signal results in a quadrature when entering the control loop 3.

The switched-mode circuit 2 of the described embodiment essentially consists of two inverters INV, two resistors R1, R3 and one capacitor C1. In this embodiment, the switched-mode control circuit 1 is used in a switched-mode audio power amplifier, which has a switching frequency (F_switch) of approximately 80 kHz and generates an output signal that is a sine wave of 6 kHz. The V_IN input signal for the switched-mode circuit 2 is also a sine wave of 6 kHz, but a low-amplitude one. The drawing also shows an additional signal, V_START PULSE, but this is only used when starting up the system. The feedback signal of the switched-mode circuit 2 is self-oscillating and is combined with synchronization pulses. The synchronization pulses are generated by using the outputs of the two multipliers XA and XB, which are coupled and transferred to an inverter (INV). The output voltage of the control loop is supplied to the capacitor C10 via an inverter and two resistors R9, RIO.

The components between the four multipliers, i.e. the control loop comprising the two resistors R5, R8 and the two capacitors C2, C5, can control the shape and width of the protected band.

The position of the protected frequency band is determined by the sine and cosine signals which together form the reference signal in this embodiment.

The implementation shown in FIG. 2 represents one possibility. A completely digital version is possible as well.

FIG. 3 shows the synchronization pulses that are added to the V_IN input signal. The signal is measured at V_COMP in FIG. 2. The added synchronization pulses achieve preferred switching moments when the V_COMP signal is present at the input of a comparator, for example the first port of an oscillator.

FIG. 4 a) shows the spectrum of the unfiltered output of the switched-mode circuit 2 for prior-art operation. The F_switch switching frequency is not damped, and the audio output has only minimal damping around the F_center frequency. FIG. 4 b) shows the spectrum of operation with the inventive frequency protection. The spectrum has a marked gap around 1 MHz, i.e. the F_protected frequency. In this embodiment, the reduction obtained at this point is approximately 30 dB. The F_switch switching frequency is again not damped, and the audio output has more damping around the F_center frequency than in FIG. 4 a), but this can be compensated by the product using the inventive switched-mode control circuit.

The invention may be summarized as a switched-mode control circuit (1) for a switched-mode power supply or an audio amplifier comprising a monitoring loop (3) for the output signal of the switched-mode circuit (2). A tuner (7) supplies the reference signal, which is related to the protected frequency or frequency band. The monitoring loop (3) comprises two quadrature mixers (4, 5) with a filter (6) in between and generates a correction signal, which leads back to the switched-mode circuit (2). The corrective changes performed by the monitoring loop (3) are synchronization pulses that are added to the reference signal. The synchronization pulses cause a shifting in time of each switching position for the switched-mode circuit (2).

1. A switched-mode control circuit (1) generating an output signal and comprising a switched-mode circuit (2) that is indirectly coupled to a tuner (7), which supplies the switched-mode control circuit (1) with a reference signal comprising, or related to, a frequency or frequency band that is to be protected, characterized by a monitoring loop (3) for monitoring the output signal.

2. A switched-mode control circuit (1) as claimed in claim 1, characterized in that the monitoring loop (3) comprises:
a means for receiving a reference signal that comprises, or is related to, the protected frequency or frequency band,
a means for detecting the interference within the protected frequency band present in the output signal, and
a means for introducing corrective changes in the output signal.

3. A switched-mode control circuit (1) as claimed in claim 2, characterized in that the means of the monitoring loop (3) for receiving the reference signal, comprising the protected frequency or frequency band and the output signal, are two quadrature mixers (4, 5) coupled by a filter (6).

4. A switched-mode control circuit (1) as claimed in any one of the preceding claims, characterized in that the monitoring loop (3) has
a means for generating a correction signal, and
a means for introducing corrective changes in the output signal of the switched-mode circuit (2).

5. A switched-mode control circuit (1) as claimed in claim 4, characterized in that the corrective changes are synchronization pulses.

6. A switched-mode control circuit (1) as claimed in any one of the preceding claims, characterized in that a filter (8) is coupled between the output of the switched-mode circuit (2) and the input of the monitoring loop (3).

7. A method of diminishing the electromagnetic emission of a switched-mode circuit (2) that is indirectly coupled to a tuner (7), which supplies a reference signal comprising a frequency or frequency band that is to be protected, characterized by the steps of:
receiving the reference signal that comprises the protected frequency or frequency band,
monitoring the frequency components of at least a small frequency band of the output signal of the switched-mode circuit (2),
detecting interference signals in the protected frequency or frequency band, and
introducing corrective changes in the output signal so as to create a hole around the protected frequency or frequency band.

8. Use of a switched-mode control circuit (1) generating an output signal and comprising a switched-mode circuit (2) that is indirectly coupled to a tuner (7), which supplies the switched-mode control circuit (1) with a reference signal comprising, or related to, a frequency or frequency band that is to be protected in a product that is simultaneously trying to both receive a signal at the protected frequency or frequency band and to diminish the product's own electromagnetic emissions created by interference with the aim of generating a powerful audio signal.
